(19) United States
(12) Patent Application Publication
(10) Pub. No.: US 2010/0086887 A1
(43) Pub. Date: Apr. 8, 2010

(54) CANDLE WITH A BURN-THROUGH BARRIER

(76) Inventor: Herbert Klewe, Dusseldorf (DE)

Correspondence Address: SUNIL WIJERATNE, 327 GRADY DRIVE, WOODBRIDGE, NJ, 07095, US

(21) Appl. No.: 12/443,133

(22) PCT Filed: Sep. 25, 2007
(86) PCT No.: PCT/DE07/01729

§ 371 Date: Mar. 26, 2009

(30) Foreign Application Priority Data
Sep. 26, 2006 (DE) 20 2006 014 880.9
Jun. 26, 2007 (DE) 20 2007 008 957.0

(51) Int. Cl. F23D 3/16; C09J 5/02

(52) U.S. Cl. 431/291; 156/227; 156/322

(57) ABSTRACT

The disclosure relates to a candle with a burn-through barrier, including a wick surrounded by a candle body. The burn-through barrier also covers at least partially the periphery of the candle body. Protrusions can be arranged in a base of the burn-through barrier.

The invention relates generally to a candle with a burn-through barrier, and also to a method for the manufacturing thereof.

Candles with a burn-through barrier, which must be distinguished from what are known as tea lights, are known for example from DE 20 2006 002 696 U1 which provides, as the burn-through barrier, a candle plate, the dimensions of which are smaller than those of the candle body and which separates the wick from an underlay arranged therebelow. The candle plate is attached in the region of the standing surface of the candle and substantially not visible when in use, wherein the candle plate can selectively be integrated into the candle, and is arranged there so as to be substantially concealed, in particular between the candle blank and a dipping wax layer, or else, in the form of an adhesively bondable candle plate, at most completely covers the region of the standing surface of the candle. Drawbacks of the known candle are in particular the circumstance that it may not be seen, after attachment to a flower arrangement, to be burn-through-safe, and that a burn-through barrier of this type can in practice be provided substantially only in pillar candles, but not for example also in tapered candles. The known candle provides in a plate of the burn-through barrier angular or crescent-shaped cuts which are kinked upward or downward about a straight line; a drawback of this is that the candle body shifts, as a result of its inherent weight, the folded-up portions completely back into the corresponding cutout in the plane of the plate, so that the downwardly formed cuts improve the adhesion at most when coated with dipping wax.

DE 20 2005 020 246 U1 describes a tea light casing which is made of aluminum and from the substantially flat bottom of which a side wall, which is embodied with an undulating structure, extends, wherein conventionally the tea light is completely incorporated in the tea light casing and the tea light body liquefies as the tea light burns. The tea light casing has a height-to-diameter dimension ratio, which is typical of tea lights, of about 3:4.

DE 201 21 402 U1 describes a candle fire protection device in which a funnel-shaped attachment, which is provided on the candle at the height at which it is desirable for the candle to stop burning, is filled with extinguishing agent and, on reaching a specific burn-down height, extinguishes the flame of the wick. A drawback of this candle is the fact that the extinguishing agent must be applied in each case by hand, and that, specifically in the event of intended extinguishing in the region of the bottom surface of the candle, the risk of burn-through to combustible items located below the candle cannot be ruled out, as the central region of the candle burns down more rapidly than the edge region.

It is an object of the invention to provide a burn-through barrier in which the protrusions are not flattened even when loaded with the inherent weight of a candle. A further object of the invention is to provide a candle in which the burn-through barrier can easily be applied and indicates to the consumer in a comprehensible manner that it is a candle with a burn-through barrier and thus without the risk of burn-through. A further object of the invention is to show a method with which a candle can be provided with a burn-through barrier in an economical manner.

According to the invention, this object is achieved by the features disclosed in the independent claims.

As a result of the configuration of the protrusions, the burn-through barrier according to the invention avoids the risk of folding-over about a bending line and thus the risk of the protrusions, which are provided for better bonding, being displaced flat into the plane of the bottom of the burn-through barrier. Instead, there remains, even in the case of pressing-down, as a result of the configuration with at least one surface which protrudes upward through at least 30° relative to the bottom, a three-dimensional region having advantageous properties for connecting to a candle. Particularly favorable ratios are attained if the vertical component of the at least one surface predominates, i.e. the angle of inclination forms more than 45°. Preferably, the protrusion has a thickness, which is altered as a result of plastic deformation, relative to the bottom of the burn-through barrier in order to counteract folding-back of the protrusions. A correspondingly shaped punching tool can be used to produce the protrusions. If a plurality of protrusions are provided in a burn-through barrier, the tool can have a plurality of corresponding shapes, or it is used in the desired number of protrusions.

Expediently, the line in which the protrusions intersect the plane of the bottom of the burn-through barrier is also embodied in a curved manner and has preferably a narrow radius in the manner of a crescent or moon segment. This further impedes folding-back of the protrusions. Alternatively, a fold line of this type can also have a straight stretch.

Expediently, the protrusions are punched out of the material of the burn-through barrier and protrude in the direction toward the candle. It is however also possible to provide branches on the protrusions, so that in the case of a change of the orientation of a protrusion, these branches protrude as small thorns in the direction toward the candle body.

Preferably, two respective adjacent protrusions form a pair, the two protrusions each being offset from each other by 90°. This ensures, even in the event of a load peak in one direction, for example as a result of improper insertion of the candle, that a protrusion of the pair has at its line of intersection with the bottom of the burn-through barrier a component parallel to the direction of the load peak and thus remains substantially intact.

Expediently, a plurality of protrusions are arranged over the surface of the bottom of the burn-through barrier, so that a candle is bound to the burn-through barrier as uniformly as possible over the entire surface of the burn-through barrier. Once the above-described pairs are formed, then preferably the pairs are each arranged at equidistant angles to one another. Then, the burn-through barriers can be stacked more easily. Alternatively, it is possible to arrange the protrusions or the pairs at random. Then, the burn-through barriers, when they are stacked, can be separated more easily.

According to the invention, the burn-through barrier at least partially surrounds the circumference, adjoining the bottom of the candle, of the candle body. Preferably, this region is configured all the way round, so that in the case of a candle having a round, quadrangular or other polygonal circumference, the entire circumference of the candle is surrounded by a lower edge which is visible even when the candle is placed in position. This lower visible edge is preferably provided in conspicuous coloring or colored material, thus allowing a clear demarcation against the coloring of the candle. Alternatively, merely certain regions of the lower edge of the casing surface of the candle body can be equipped with a corresponding marking which is expediently embodied in one piece with the burn-through barrier or is connected thereto.

Preferably, the edge is made of aluminum which is particularly suitable as a material for the burn-through barrier and which can easily be deformed, even in the case of a thin-walled configuration, without becoming damaged. Thus, the burn-through barrier hardly increases the weight of the candle. The burn-through barrier is preferably formed as an aluminum layer which is rolled out so thin that it can easily be cut to size and can also be arranged in a flexible manner on the bottom of the candle. This is significant especially when—unlike in the case of the pillar candle which has a substantially flat bottom surface—the burn-through barrier is to be arranged on a tapered candle, the foot of which in many cases tapers conically, for adaptation to conventional candle holders, and in addition can have a spherical bottom surface.

According to a first configuration of the invention, provision is made for the burn-through barrier to be embodied as foil which at least predominantly covers the bottom surface of the candle. In this case, it is significant that specifically the region of the wick, or of the wicks in the case of multiple-wick candles, is covered at least in so far as burning-through of the wick to combustible material arranged below the candle is prevented.

The burn-through barrier is expediently fastened to the candle by means of an adhesive. In this way, even burn-through barriers made of material which has difficulty adhering to wax, such as aluminum, can be connected to the candle in a simple and reliable manner. In addition, the burn-through barrier can also easily be redetached so that, when used for example in candle holders protected against burn-through, the burn-through barrier is also removable.

However, in accordance with a method according to the invention for manufacturing a burn-through barrier which is connected to a candle, provision is made for a burn-through barrier receiving the candle to be brought to a heated temperature of from expediently 30 ° C. to 70 ° C., preferably 45 ° C. to 55 ° C., and then to be attached to the candle, so that the region of the candle body that enters into contact with the burn-through barrier is softened and the softened material of the candle body, usually paraffin, hardens as an adhesion promoter and improved adhesive bonding of the two parts is attained. As a result of the softening of the candle body, the penetration resistance for the protrusions of the burn-through barrier is also reduced and the risk of accidental flattening is further reduced. Advantageously, the burn-through barrier can be heated during bending, so that the process heat of the manufacturing method is advantageously utilized during connecting to the candle. The material of the candle body thus serves advantageously instead of an adhesive as an adhesion promotion layer, the connection by the protrusions penetrating the candle body being further improved, so that even if aluminum, which per se repels candle material, is used as the material for the burn-through barrier, there is produced a connection which is so good that the provision of a mandrel for skewering the candle can preferably be dispensed with. It will be understood that it is also possible to heat the lower region of the candle to achieve the same purpose, although this is less in compliance with the requirements for a highly automated reproducible process. However, the burn-through barrier can particularly advantageously be maintained even during arranging in candle holders with corresponding depressions, in particular in the case of tapered candles, as the burn-through barrier can, on pressing of the candle into the candle holder, easily be deformed or else be notched at the location where mounting is carried out via notches formed in the candle. The burn-through barrier, which is embodied in a cup-shaped manner owing to the visible edge, then serves, even in the event of burn-down of the candle in a candle holder, in a particularly advantageous manner as a vessel for collecting the burned residues, so that the candle holder no longer has to be cleaned, or no longer remains contaminated by wax residues, when exchanging the candle.

The surface of the burn-through barrier that is remote from the candle body has preferably a wax-repellent surface, so that bonding-on of the candle, which is provided with the burn-through barrier, by means of wax is impeded. It is however possible to allow, by way of an adhesion promoter on this surface, better adhesive bonding to wax.

Preferably, provision is made for the burn-through means to completely seal the bottom surface of the candle and to have as an edge a lateral fold-down which protrudes beyond the lateral circumference, adjoining the bottom surface, of the candle body in such a way that, in a candle having a round cross section, a burn-through barrier is produced as a receptacle in the manner of a cup. In the case of other candle cross sections, the receptacle is adapted accordingly to the lower shape of the candle. The height of the edge is however in all cases small compared to the height of the candle, preferably less than 1/10, particularly preferably less than 1/20 of the height of the candle. The height of the edge is also small in relation to the diameter of the bottom surface in a pillar candle. In the case of a tapered candle, the height of the edge is substantially of the order of magnitude of the diameter of the bottom surface of the candle body and covers, in the case of a conically downwardly tapering lower foot region of the tapered candle, preferably the entire conical region.

According to a second configuration of the invention, the peripheral edge of the burn-through means is embodied as a strip which is peripherally attached in the foot region, adjoining the bottom surface of the candle, of the candle, wherein there are preferably provided on the strip, by cutting into the strip, fold-down members which are, for example, triangularly or rectangularly shaped, are folded down from the strip substantially perpendicularly and are placed around the bottom surface of the candle. The placing next to one another or one above another of the folded-down regions forms for the bottom surface of the candle body an at least predominantly closed underlay which effectively prevents burning-through of the wick.

According to a third configuration of the invention, provision is made for the burn-through barrier to be manufactured as a three-dimensional aluminum part which is approximated or adapted to the contour of the candle body.

According to a first embodiment of the burn-through barrier as a three-dimensional part, the burn-through barrier is manufactured as a one-piece, smooth-walled part, made preferably of aluminum, but alternatively also of a plastics material which is non-combustible or difficult to ignite, and is placed on the bottom region of the candle. A burn-through barrier of this type displays high rigidity and insensitivity to damage, but is as a result susceptible to play with the candle body and requires correspondingly high assembly costs for connecting the two parts, the candle and burn-through barrier.

According to a second embodiment of the burn-through barrier as a three-dimensional part, the burn-through barrier consists of a three-dimensionally crinkled aluminum cup which is approximated to the contour of the foot region of the candle body and can therefore be connected thereto with an overmeasure and can easily be connected to the candle by pressing-in. Furthermore, a burn-through barrier easily deforms during attachment into the candle holder or during connecting to a wreath or the like by means of wire, without this giving rise to the risk of the candle sliding out of the holder. It is possible to border the upper region of the crinkled aluminum body or to provide it in the edge region with a claw configuration into which a wire can be introduced for the purposes of fixing. Furthermore, the edge can be dyed as a special marking or be polished so as to stand out in terms of its sheen from the remainder of the body which is preferably made of aluminum. Furthermore, the crinkling also allows approximation to a broad range of contours without the crinkled foil having to be specially cut to size as a result.

According to the invention, the candle is permanently connected to one of the above-cited burn-through barriers according to the invention. Expediently, the permanent connection is produced in that a material of the candle body is heated and, after hardening, serves to promote adhesion to the burn-through barrier. According to the invention, the material is heated in that the burn-through barrier itself is heated.

Further advantages and features will emerge from the subsequent description and also from the dependent claims.

The invention will be described in greater detail hereinafter based on a plurality of preferred exemplary embodiments and with reference to the appended drawings, in which:

FIG. 1 is a side view of a first preferred exemplary embodiment of a burn-through barrier according to the invention with a candle which is embodied as a pillar candle

FIG. 2 is a perspective view from below of the candle from FIG. 1

FIG. 3 is a perspective view from below during application of the burn-through barrier

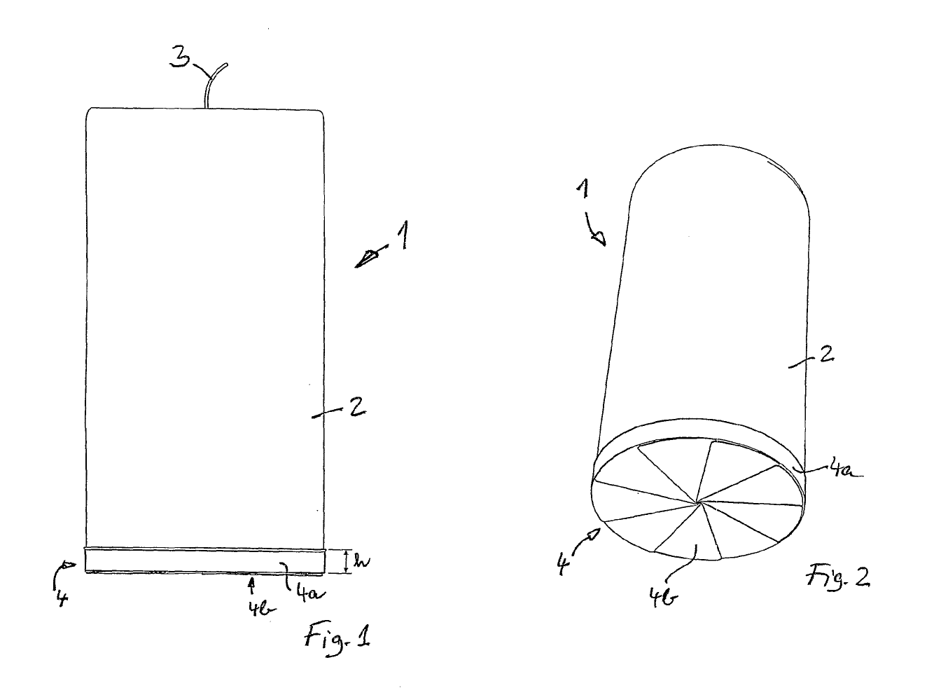

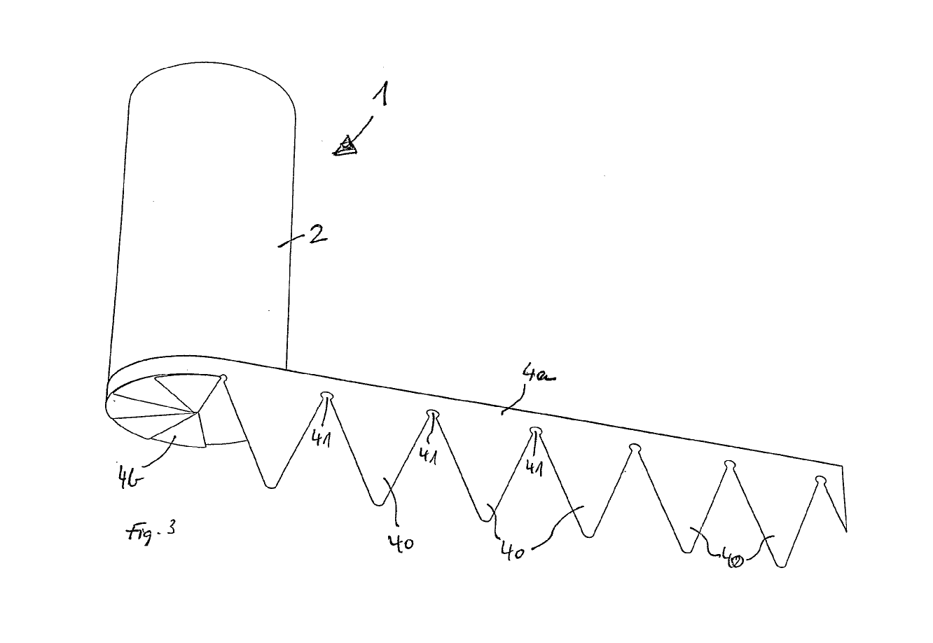

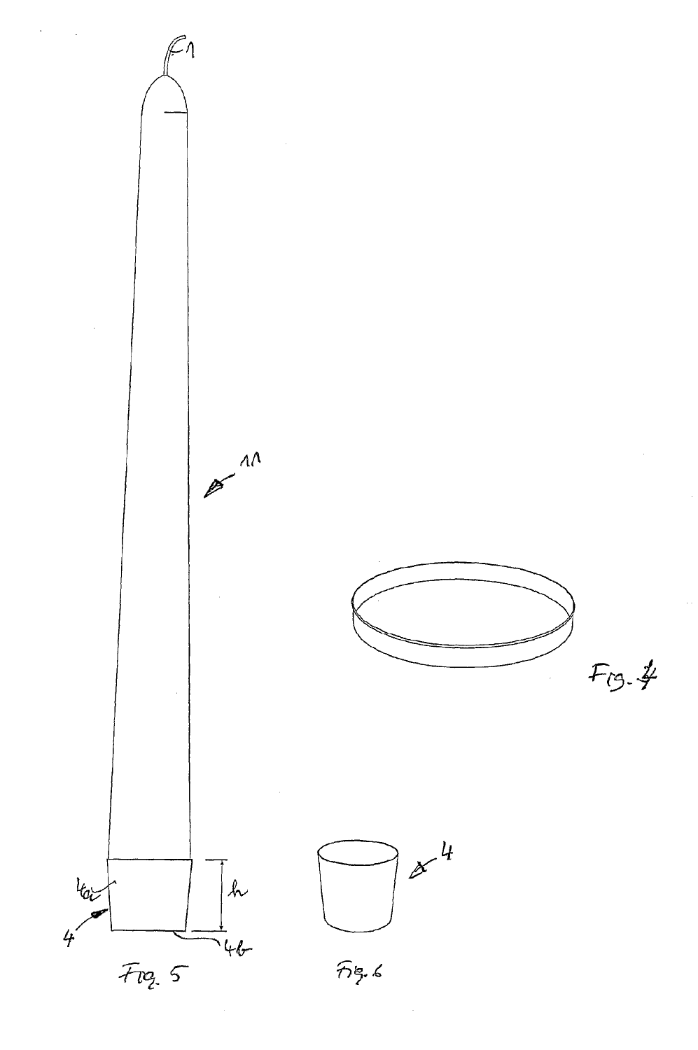

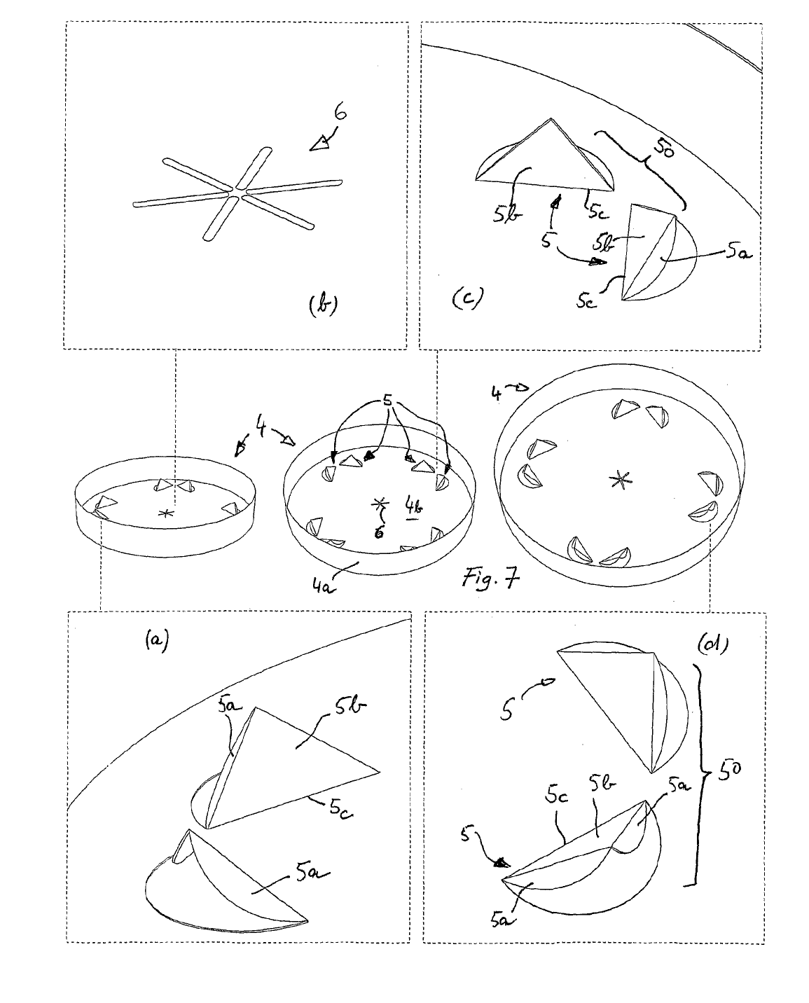

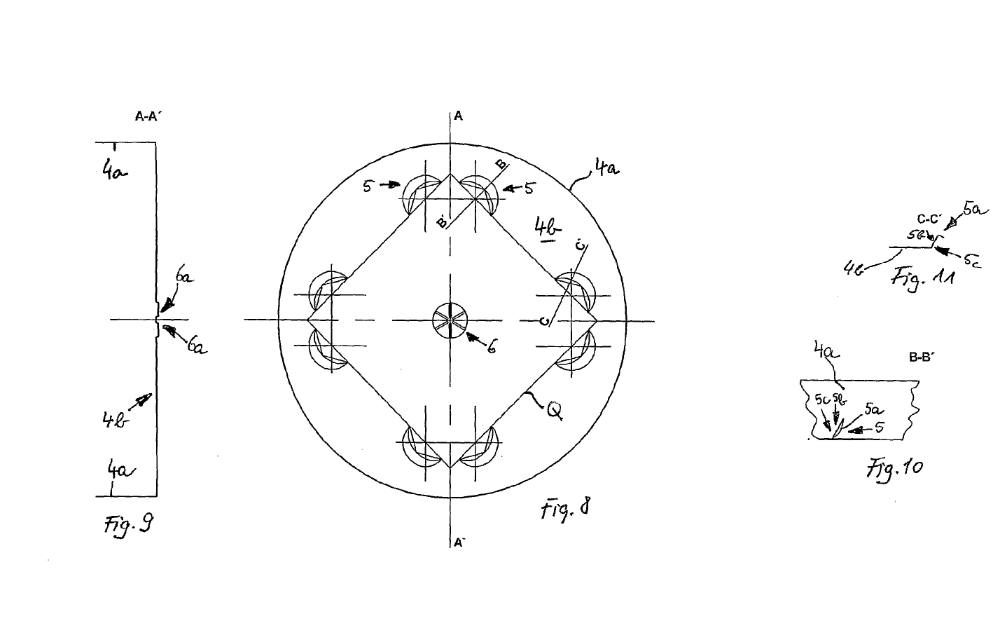

FIG. 4 shows an alternative configuration of a burn-through barrier for the candle from FIGS. 1 to 3

FIG. 5 shows a second preferred exemplary embodiment of a burn-through barrier according to the invention with a candle which is embodied as a tapered candle

FIG. 6 shows a burn-through barrier for the candle from FIG. 5

FIG. 7 shows three different perspectives of the burn-through barrier from FIG. 4 with protrusions protruding in the direction toward the candle, and also details thereof

FIG. 8 is a plan view of the burn-through barrier from FIG. 7 with two enlarged details

FIG. 9 is a section along the line A-A′ from FIG. 8

FIG. 10 is a section along the line B-B′ from FIG. 8

FIG. 11 is a section along the line C-C′ from FIG. 8

The candle 1 illustrated in FIGS. 1 to 3 is in the present case configured as a pillar candle and has a substantially cylindrical candle body 2 which is penetrated by a central wick 3. The region of the wick that protrudes beyond the candle body 2 may be seen in FIG. 1. A burn-through barrier 4, which consists of a strip 4a, completely surrounding the circumference of the candle body 2, and a bottom surface 4b, is provided in the foot region of the candle 1. The burn-through barrier is made of aluminum and has on its side facing the candle body 2 an adhesive which is sprayed onto the components of the burn-through barrier 4 and ensures permanent but releasable connection of the burn-through barrier 4 to the candle body 2. The adhesive can however also be applied only to parts of the burn-through barrier 4 or not at all.

The region of the strip 4a has on its outwardly facing surface a gleaming consistency which immediately informs an observer that the candle is provided in the bottom region with a burn-through barrier. The height h of the strip 4a is small both compared to the height and compared to the diameter of the candle body, so that the decorative effect of the candle 1 is hardly impaired at all. At the same time, the sight of the strip 4a, which is visible even when the candle is placed in position, of the burn-through barrier 4 imparts to the observer a feeling of safety that a burn-through barrier 4 is provided.

With reference to FIG. 3, a preferred method will be described for manufacturing of a candle 1 with a wick 3, which is surrounded by a candle body 2, and with a burn-through barrier 4, in which the burn-through barrier 4 has a strip 4a made of aluminum material. Triangular strands 40 protrude laterally from the strip 4a as fold-down regions 40. The strip 4a is applied over the circumference of the candle body 2 close to the bottom surface 2a and the fold-down regions 40 are kinked in each case through 90° in order to form the bottom region 4b by jointly overlapping. This method can be automated in a simple manner in that the candle body 2 is guided along a strip 4a, which can also be embodied as an endless strip, and which was preferably provided with an adhesive layer, and firstly the strip 4a is fastened to the circumferential surface of the candle body 2 and subsequently the fold-downs 40 are placed around, preferably automatically by rolling the candle 1 along a corresponding device. This method can easily be carried out by machine.

FIG. 3 shows that the adjacent regions of the fold-downs 40 are separated from one another by stiffening corrugations 41 which effectively prevent tearing of the foil which is made of thin aluminum. It may be seen that fold-downs which are configured in a manner other than triangularly may equally well be selected. It may also be seen that two strips 4a with triangular fold-downs 40 may be cut to size, interlocked in a material-saving manner, from a strip which is wider than that shown in FIG. 3 merely by the width of the strip 4a.

FIG. 4 shows an alternative configuration of a burn-through barrier 4 for a pillar candle, in which the bottom 4b and the edge 4a are produced from a one-piece aluminum part which is adapted to the dimensions of the bottom region of the candle body 2. It will be understood that a further possibility, instead of a smooth-surfaced configuration of the burn-through barrier, is what is known as a crinkled burn-through barrier in which the aluminum material is shaped with a considerable fold-creation by crinkling, wherein this method has the advantage that the burn-through barrier is readily deformable and, in addition, can be adapted more easily to difficult, non-round or symmetrical geometries of a candle body.

FIG. 6 shows a candle 11 which is embodied as a tapered candle and comprises a wick 3 in a candle body 3. A cup or beaker-shaped burn-through barrier 4, which is made of aluminum and has a bottom region 4b and a wall region 4a, is attached in a base region with a hight h of the candle body. The base region of the tapered candle is at the same time that region which tapers conically downward and conventionally is received in a candle holder.

The burn-through barrier 4, which is illustrated in FIG. 6 without the candle 11 inserted, covers with the base region substantially that region of the candle 11 that is hardly perceived by an observer; nevertheless, it imparts the feeling of safety when the edge 4a of the candle is recognized as the burn-through barrier. It may be seen that the inner cone of the burn-through barrier 4 corresponds to the cone of the base region of the candle 1.

It is possible to label the bottom region 4b of the burn-through barrier 4 in each case with special features of the corresponding burn-through barrier.

In FIGS. 1 to 6, the protrusions 5, which may be seen in FIGS. 7 to 10, have been omitted for the sake of clarity. FIG. 7 shows that a total of eight protrusions 5, which make up less than one fifth of the surface area of the bottom 4b, are arranged over the bottom 4b of the burn-through barrier 4. The maximum height of the protrusions 4 is less than half the height of the edge 4a of the burn-through barrier 4.

Each protrusion 5 consists of a half-round material portion which is punched out of the bottom 4b and bent upward through 50° along a fold line 5c, wherein two quarter circle segments 5a are folded down from along two secants, so as to produce a triangular surface 5b, of which the angle opposing the bottom 4b assumes substantially 90°. The angle between the fold-down 5a and triangle 5b is in this case approximately 90°. The planes of the fold-downs 5a and of the triangle 5b are therefore inclined both relative to the plane of the bottom and relative to the planes which are normal thereto and in which the direction of insertion of a candle lies. Moreover, the planes of the fold-downs 5a and of the triangle 5b form wedge surfaces in the direction toward the direction of insertion of a candle, so that penetration into the body of the candle is facilitated. Moreover, this simple measure effectively provides stiffening of the protrusions 5 and thus prevents the protrusions 5 from being pressed flat by a candle. The protrusions 5 are thus embodied like a casing surface segment of a pyramid. It will be understood that, alternatively thereto, the protrusions can also be embodied as the casing surface segment of other symmetrical or asymmetrical bodies such as cones, truncated cones, tetrahedrons, cylinders or the like.

Instead of by folding, a protrusion can also be formed with a spherical configuration in that a semicircular recess is formed on the rectilinear circumferential portion of the recess and bent upward along the semicircular circumferential portion, thus imparting to the protrusion 5 a spherical curvature to form a three-dimensional structure in the space above the bottom 4a.

Two respective protrusions 5 form a pair 50 of adjacent protrusions 5 which are positioned rotated or offset relative to each other by 90°. Overall, four pairs 50, which are mutually offset by 90° about a center point region 6 of the bottom 4b, are provided, cf. FIG. 8. In the present case, the rectilinear fold lines 5c of the two protrusions 5 enclose a right angle, the bisectors of which intersect at the center point of the bottom 4b.

The center point region 6 has a center point which is formed flush with the bottom 4b toward which six lines 6a, which are sunk by an amount corresponding to the thickness of the bottom 4b, are directed. These lines serve as a positioning aid for a subsequent automated step for connecting to a candle body or as optical marking of the center point for a user.

FIG. 8 also shows that the fold lines 5c all coincide with the edges of an illustrated square Q. Accordingly, a tool is held, preferably during the production of the protrusions 5, against the upwardly pointing side of the bottom 4b; the tool is preferably at the same time embodied as a punching tool for producing the center point region 6.

As may clearly be seen in the sectional view according to FIG. 9, the depth of the impressed line 6a corresponds roughly to the thickness of the bottom 4b. FIG. 10 shows the angle of attack of the triangle 5b of approx. 50° relative to the plane of the bottom 4b along the fold line 5c, and the ratio of the vertical height of the protrusion 5 to the edge 4 of approximately one third. FIG. 11 shows the right angle between the triangular surface 5 and fold-down 5a.

The burn-through barrier 4 is heated prior to connecting to a candle body and then pressed against the base of a candle. As a result of the temperature of the burn-through barrier 4, the material of the candle body is softened and the soft paraffin clings to the bottom 4b; at the same time, the protrusions 5 penetrate into the softened material of the candle body. It is possible then to rotate the candle body a bit further relative to the burn-through barrier 4 in order to allow material of the candle body to issue from the recesses of the burn-through barrier 4.

The invention has been described hereinbefore based on two exemplary embodiments showing candles with burn-through barriers having a relatively smooth structure. It will be understood that the burn-through barriers, which have an edge which is visible at the circumference of the candle, can also be embodied as a folded, bonded-on foil or as a crinkled three-dimensional body which are attached to the bottom region and the adjoining visible circumferential region of the candle. It will also be understood that the number, orientation and dimensions of the protrusions of the burn-through barrier can be adapted to the composition of the candle body.

1-50. (canceled)

51. A candle with a wick surrounded by a candle body,
wherein a burn-through barrier with a bottom region is firmly attached to a bottom surface of the candle body,
wherein a portion of a strip protruding from the bottom region of the burn-through barrier is attached in a foot region of the lateral surface of the candle body and surrounds at least certain portions of the circumference of the candle body,
wherein the burn-through barrier is configured as a foil member, and
wherein a height of the strip portions is small compared to a height of the candle body

52. The candle as claimed in claim 51, wherein the burn-through barrier includes an aluminum layer.

53. The candle as claimed in claim 51, wherein the foil covers the complete bottom surface of the candle body.

54. The candle as claimed in claim 51, wherein the burn-through barrier is attached to the candle body using an adhesive.

55. The candle as claimed in claim 51, wherein the burn-through barrier is detachable from the candle body, and wherein the burn-through barrier is of much less weight compared to the candle such that the burn-through barrier is easily carried with the candle.

56. The candle as claimed in claim 51, wherein the burn-through barrier comprises a strip, wherein fold-down members protrude from the strip to be folded from the strip onto the bottom surface of the candle body, such that the fold-down members cover substantially the complete bottom surface of the candle body so as to define the burn-through barrier.

57. The candle as claimed in claim 51, wherein the burn-through barrier is designed as crinkled aluminum body having an angled edge region, the angled edge region protruding beyond a casing region of the candle body, and wherein the casing region is arranged close to the bottom of the candle body.

58. The candle as claimed in claim 51, wherein the burn-through barrier is designed as a cup, and wherein a lower region of the candle body is completely inserted into the cup.

59. The candle as claimed in claim 51, wherein the bottom region of the burn-through barrier comprises protrusions, the protrusions being produced out of the burn-through barrier material, wherein at least one of the protrusions comprises at least one surface protruding upwardly from the bottom region of the burn-through barrier at an angle exceeding 30° and preferably 45°.

60. A disposable burn-through barrier for assembly with a candle, comprising a substantially flat bottom region and a circumferential strip portion extending substantially perpendicular from the bottom region, wherein the bottom region and the strip portion are produced of aluminum, wherein the bottom region comprises adjacent protrusions and apertures, wherein the protrusion is produced by cutting a bottom region material segment and bending upward the segment, such that the bent segment defines the protrusion and the removed segment defines the aperture.

61. A candle with a wick surrounded by a candle body,
wherein a burn-through barrier is attached to the candle body,
wherein the burn-through barrier comprises a substantially flat bottom region and at least one strip portion protruding substantially perpendicular from the bottom region,
wherein the bottom region of the burn-through barrier covers substantially the complete bottom surface of the candle body,
wherein the strip portion of the burn-through barrier is attached to a lateral surface of the candle body adjoining the bottom surface of the candle body,
wherein the bottom region comprises at least one protrusion and at least one aperture, the at least one protrusion being arranged adjacent to the at least one aperture,
wherein the protrusion is produced by cutting a material segment of the bottom region and bending upward the segment, such that the bent segment defines the protrusion and the removed segment defines the aperture, and
wherein the at least one protrusion comprises a surface including an angle with the bottom region of at least 30°.

62. The candle as claimed in claim 61, wherein the protrusions are punched out of the circular bottom region and are subsequently permanently deformed, and wherein the protrusions attach the burn-through barrier to the candle body such that the bottom region of the burn-through barrier is immediately adjacent to the bottom surface of the candle body.

63. The candle as claimed in claim 61, wherein a plurality of protrusions is provided, the protrusions being arranged rotated relative to one another, and wherein two protrusions being mutually offset by 90° define a pair of adjacent protrusions.

64. The candle as claimed in claim 63, wherein a plurality of pairs of adjacent protrusions are provided offset from one another at a predetermined equidistant angle, preferably 90°.

65. The candle as claimed in claim 51, wherein the burn-through barrier adheres to the candle body through candle material melted responsive to a contact with the burn-through barrier having an elevated temperature.

66. The candle as claimed in claim 51, wherein the candle is selected from the group comprising pillar candles and tapered candles.

67. A method for manufacturing a candle provided with a burn-through barrier,
the candle comprising a wick surrounded by a candle body,
the candle body having a bottom surface and a lateral surface,
wherein a strip with a plurality of laterally protruding fold-down members is attached to the lateral surface of the candle body close to the bottom surface of the candle body, and
wherein the fold-down regions are folded onto the bottom surface of the candle body to form a bottom region which substantially covers the bottom surface of the candle body.

68. A method for attaching a disposable burn-through barrier to the candle body of a candle, wherein the candle body firmly surrounds a wick, comprising the steps:
heating the burn-through barrier to a temperature above room temperature;
attaching the burn-through barrier to the candle body in such a manner that material of the region of the candle body that enters into contact with the burn-through barrier is softened; and
allowing the softened material to harden, such that the hardened material achieves a bonding of the burn-through barrier and the candle body.

69. The method as claimed in claim 68, wherein the burn-through barrier is heated during a bending operation in the manufacturing process of the burn-through barrier.

70. The method as claimed in claim 68, wherein the burn-through barrier comprises at least a protrusion, wherein the candle body is heated prior to attachment of the burn-through barrier such that a penetration resistance of the candle body is reduced.

71. A method of using an aluminum member comprising a substantially flat bottom region and a circumferential strip portion extending substantially perpendicular from the bottom region and having a strip height, said method comprising using said aluminum member as a disposable burn-through barrier for subsequent attachment to a candle body having a height that is noticeable higher than the highest strip height.
